(19) United States
(12) Patent Application Publication
(10) Pub. No.: US 2009/0266113 A1
(43) Pub. Date: Oct. 29, 2009

(54) Appliance Having A Vibration Detection Device

(75) Inventors: Thomas A. Musser, St. Charles, IL (US); Gregory A. Peterson, South Barrington, IL (US)

Correspondence Address: HARNESS, DICKEY & PIERCE, P.L.C., P.O. BOX 828, BLOOMFIELD HILLS, MI, 48303, US

(73) Assignee: EMERSON ELECTRIC CO., St. Louis, MO (US)

(21) Appl. No.: 12/111,396

(22) Filed: Apr. 29, 2008

(51) Int. Cl. D06F 37/20; H02K 5/00

(52) U.S. Cl. 68/12.06; 310/68 B; 68/12.16

(57) ABSTRACT

A laundry appliance having a vibration detection device includes a frame, a drum received in the frame, and an electric motor assembly for driving the drum. The electric motor assembly includes an electric motor and an integrated motor controller mounted to the electric motor. An accelerometer as the vibration detection device is provided in the motor controller for detecting vibration of the drum. By integrating the accelerometer to the electric motor assembly, the laundry machine can more accurately detect vibration of the drum and the time and cost for assembling the washing machine are reduced.

### FIELD

The present disclosure relates generally to appliances and more particularly to appliances incorporating a vibration detection device.

### BACKGROUND

The statements in this section merely provide background information related to the present disclosure and may not constitute prior art.

A laundry appliance, such as a horizontal-axis washing machine, or a dryer, generally includes an appliance frame, a tub provided in the appliance frame, and a drum disposed horizontally in the tub. The drum includes a rear end extending outwardly of the tub and rotatably connected to a motor so that the motor drives the drum to rotate around a horizontal axis. Through the spinning of the drum, the clothes received inside the drum are tumbled for washing, rinsing and/or drying.

Load imbalance is a frequent problem encountered in a laundry appliance. A load imbalance may cause the drum to vibrate, resulting in an undesirable noise in the laundry appliance. When the drum with an imbalanced load spins at a relatively high speed, severe vibration may result and cause the drum to strike and damage the tub.

To reduce vibration, a vibration detection device is generally provided on the appliance frame or the tub. When vibration is detected, a control system for the laundry appliance may energize relevant circuits to balance the drum or change the spinning speed to reduce vibration. In the known laundry appliance, however, a damper assembly is generally provided between the tub and the appliance frame to insulate vibration of the drum. With the vibration damping effect applied on the tub and the appliance frame, the vibration detection device in the known laundry appliance is incapable of accurately detecting vibration of the drum.

Another method of detecting vibration in the known laundry appliance is directed to interpretation of the motor operation. When vibration occurs in the drum, the motor torque, current and voltage are changed. By monitoring the variations in the motor torque, current and voltage, vibration of the drum can be calculated. This method, however, is liable to errors because factors unrelated to vibration may also affect the operation of the motor and cause such variations.

### SUMMARY

Several embodiments described in the present disclosure provide for a laundry appliance having a vibration detection device which can more accurately detect vibration and which lead to reduced time and cost in assembling the appliance. In one form, an electric motor assembly includes an electric motor, a motor controller and a vibration detection device. The motor controller includes a controller housing mounted to the electric motor and a circuit board assembly received in the controller housing for controlling operation of the motor. The vibration detection device is integrated with the motor controller for detecting vibration of the electric motor.

In another form, a laundry appliance includes a frame, a drum rotatably supported inside the frame, and an electric motor assembly for driving the drum. The electric motor assembly includes an electric motor, a motor controller attached to the electric motor, and a vibration detection device provided in the motor controller. The vibration detection device detects vibration of the drum.

In yet another form, a horizontal-axis washing machine includes a frame, a tub provided in the frame, a drum and an electric motor assembly for driving the drum. The drum is rotatably supported in the tub and defines a chamber for receiving clothes for washing. The electric motor assembly includes an electric motor, a motor controller, and a vibration detection device for detecting vibration of the drum.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary laundry appliance in accordance with the teachings of the present disclosure;

FIG. 2 is a schematic side view of an exemplary laundry appliance in accordance with the teachings of the present disclosure;

FIG. 3 is a perspective view of an exemplary electric motor assembly used in a laundry appliance in accordance with the teachings of the present disclosure; and

FIG. 4 is a schematic block diagram of a laundry appliance in accordance with the teachings of the present disclosure.

Corresponding reference numerals indicate corresponding parts throughout the several views of the drawings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

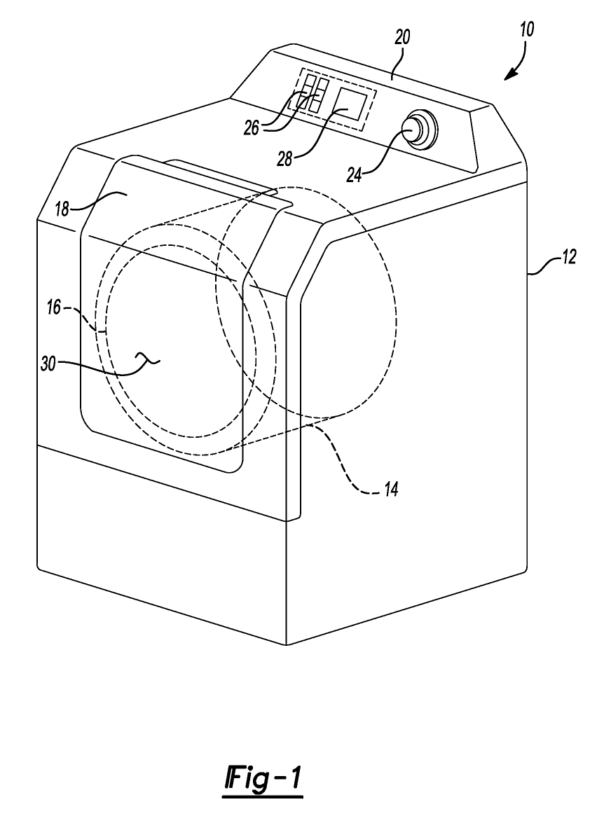

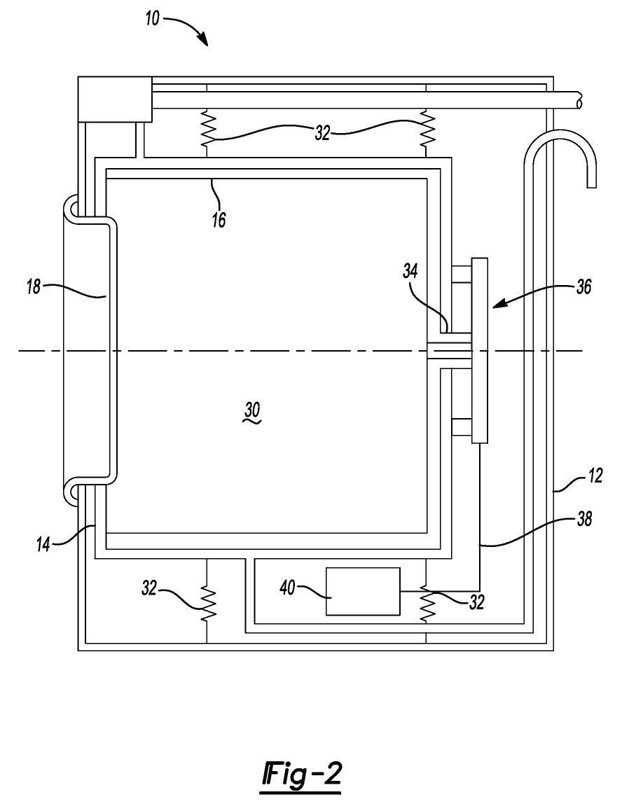

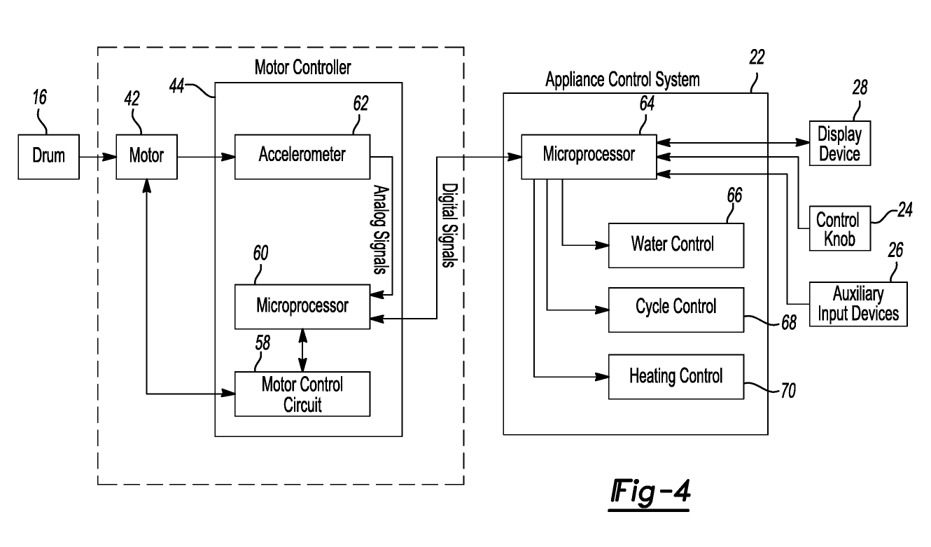

Referring to FIGS. 1 and 2, a laundry appliance in the form of a washing machine is generally indicated by reference numeral 10. The washing machine 10 is a horizontal-axis washing machine (also called a front-loading washing machine) and includes a frame 12 that houses a receptacle or tub 14. A drum 16 is rotatably supported inside the tub 14 around a horizontal axis X (FIG. 2) for receiving clothes therein for washing. The drum 16 is accessed via a pivoting door 18. The washing machine 10 has a control panel frame 20 that houses an appliance control system 22 (shown in FIG. 4). A control knob 24 and a plurality of auxiliary input devices 26 are mounted on the control panel frame 20 for selecting a desired washing cycle. A display device 28 is also mounted on the control panel frame 20 for indicating the status of the selected washing cycle.

The drum 16 defines a chamber 30 for receiving clothes for washing. A plurality of spring damper assemblies 32 are disposed between the tub 14 and the frame 12 for minimizing vibration transmission from the drum 16 to the frame 12. The drum 16 includes a rotatable shaft 34 extending outwardly of the tub 14 for engaging a drive mechanism 36. The drive mechanism 36 may include a drive belt 38 and an electric motor assembly 40. Through the drive belt 38, the electric motor assembly 40 drives the rotatable shaft 34 of the drum 16 to rotate at a predetermined speed. It should be understood and appreciated that the rotatable shaft 34 may alternatively engage the electric motor assembly 40 directly without the drive belt 38.

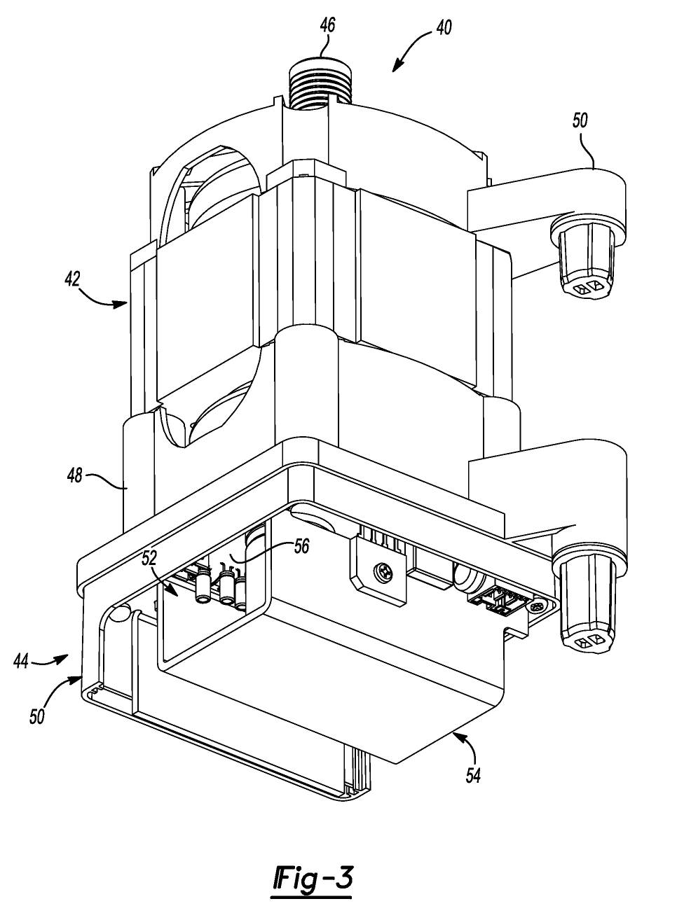

Referring to FIG. 3, the electric motor assembly 40 includes an electric motor 42 and a motor controller 44 integrated with the electric motor 42. The electric motor 42 has a rotor 46 for driving the drive belt 38 and an end housing 48 to which the motor controller 44 is attached. A mounting flange 50 may be provided to mount the electric motor assembly 40 to a panel (not shown) of the washing machine 10. The electric motor 42 can be a variable speed controlled induction motor, a brushless permanent magnet motor or a switched reluctance motor. Since the structure of the motor is known in the art, the detailed description thereof is omitted herein for clarity.

The motor controller 44 includes a controller housing 50, a circuit board assembly 52 mounted to the controller housing 50, and a protective cover 54 removably attached to the controller housing 50 for protecting the circuit board assembly 52. The circuit board assembly 52 includes a printed circuit board 56 and a variety of motor control components.

As shown in FIG. 4, the motor control components may include a motor control circuit 58, a microprocessor 60, and an accelerometer 62. The motor control circuit 58 controls the operation of the motor 42. The microprocessor 60 processes the signals from the motor control circuit 58 and the accelerometer 62, among other things, to determine an appropriate control scheme. The accelerometer 62 functions as a vibration detection device for detecting vibration of the drum 16. Because the motor assembly 40 is connected to the drum 16 and no damping effect from the spring damper assemblies 32 is applied to the motor assembly 40 and the drum 16, the accelerometer 62 can more accurately detect vibration of the drum 16 by way of detecting vibration of the electric motor assembly 40.

The appliance control system 22 is housed in the control panel frame 20 for controlling the operation of the washing machine 10. The appliance control system 22 includes a central microprocessor 64 and a variety of electric circuits operably connected to the microprocessor 64. The control circuits control a variety of functions of the washing machine 10 and may include a water control circuit 66, a cycle control circuit 68, and a heating control circuit 70, among other things. The central microprocessor 64 is operably connected to the display device 28, the control knob 24, and the auxiliary input devices 26 (shown in FIG. 1). When a user operates the control knob 24 and the auxiliary input devices 26, signals corresponding to a selected washing cycle are transmitted to the central microprocessor 64, which in turn control the various circuits 66, 68 and 70 to actuate the desired functions based on a predetermined program. The central microprocessor 64 also controls the display device 28 to indicate the status of the selected washing cycle. The central microprocessor 64 is operably connected to the microprocessor 60 of the motor controller 44 so that the central microprocessor 64 can control the functions of the washing machine 10 with feedback from the microprocessor 64 of the motor controller 44.

When vibration is detected by the accelerometer 62, the accelerometer 62 generates and transmits an analog signal corresponding to the detected vibration to the microprocessor 60 of the motor controller 44. The microprocessor 60 of the motor controller 44 may then energize relevant circuits to change the spinning speed of the drum 16 to reduce vibration. Preferably, the microprocessor 60 of the motor controller 44 may send the signals corresponding to the detected vibration to the central microprocessor 64, which, in turn, energizes a circuit responsible for a balancing function to balance the drum 16.

Apart from the advantage of accurate vibration detection, the washing machine 10 having the vibration detection device in accordance with the teachings of the present disclosure has the advantage in terms of assembly. In assembling a known washing machine having a vibration detecting device, several steps are generally required to assemble the motor, the motor controller and the vibration detection device to the drum and tub, respectively, using at least two harness connections. As such, assembling the known washing machine having the vibration detection device is not time and cost efficient.

In contrast, in the washing machine according to the teachings of the present disclosure, because the accelerometer 62 is integrated into the motor assembly 40 as a unit, it takes only one step to assemble the motor 42, the motor controller 44 and the accelerometer 62 as a unit to the drum 16 and requires only one wiring harness connection. As such, the assembly time and cost for assembling the washing machine 10 are reduced.

This description is merely exemplary in nature and, thus, variations that do not depart from the gist of the disclosure are intended to be within the scope of the disclosure. Such variations are not to be regarded as a departure from the spirit and scope of the disclosure.

What is claimed is:

1. An electric motor assembly, comprising:
an electric motor;
a motor controller comprising a controller housing mounted to the electric motor and a circuit board assembly received in the controller housing for controlling operation of the motor; and
a vibration detection device integrated with the motor controller for detecting vibration of the electric motor.

2. The electric motor assembly of claim 1, wherein the electric motor includes an end housing and the controller housing is removably mounted to the end housing.

3. The electric motor assembly of claim 1, wherein the vibration detection device is mounted to the circuit board assembly.

4. The assembly of claim 1, wherein the vibration detection device includes an accelerometer.

5. A laundry appliance, comprising:
a frame;
a drum rotatably supported inside the frame; and
a motor assembly for driving the drum, the motor assembly including an electric motor, a motor controller integrated with the electric motor, and a vibration detection device provided in the motor controller.

6. The laundry appliance of claim 5, wherein the vibration detection device includes an accelerometer.

7. The laundry appliance of claim 5, further comprising a belt connecting the motor assembly to the drum.

8. The laundry appliance of claim 5, further comprising a tub provided between the frame and the drum.

9. The laundry appliance of claim 8, further comprising a damper assembly provided between the tub and the frame.

10. The laundry appliance of claim 5, wherein the drum is horizontally supported inside the frame.

11. The laundry appliance of claim 5, wherein the laundry appliance is selected from a group consisting of horizontal-axis washing machines and dryers.

12. A horizontal-axis washing machine, comprising:
a frame;
a tub provided in the frame;
a drum rotatably supported inside the tub, the drum defining a chamber;
an electric motor assembly for driving the drum, the electric motor assembly comprising a motor, a motor controller and a vibration detection device for detecting vibration of the drum.

13. The washing machine of claim 12, wherein the vibration detection device is provided in the motor controller.

14. The washing machine of claim 12, wherein the vibration detection device is an accelerometer.

15. The washing machine of claim 12, wherein the motor includes an end housing and the motor controller is mounted to the end housing.
